(19) United States
(12) Patent Application Publication
(10) Pub. No.: US 2013/0228231 A1
(43) Pub. Date: Sep. 5, 2013

(54) MOUNTING FOR AN INJECTOR AND INJECTOR DEVICE HAVING AN INJECTOR INTEGRATED IN THE MOUNTING

(71) Applicant: EMITEC GESELLSCHAFT FUER EMISSIONSTECHNOLOGIE MBH, (US)

(72) Inventors: THOMAS NAGEL, ENGELSKIRCHEN (DE); STEFAN SEELIGER, ALTERSTEDT (DE); PETER BAUER, SIEGBURG (DE)

(73) Assignee: EMITEC GESELLSCHAFT FUER EMISSIONSTECHNOLOGIE MBH, Lohmar (DE)

(21) Appl. No.: 13/862,612

(22) Filed: Apr. 15, 2013

Related U.S. Application Data
(63) Continuation of application No. PCT/EP2011/067729, filed on Oct. 11, 2011.

(30) Foreign Application Priority Data
Oct. 14, 2010 (DE) 10 2010 048 284.6
Nov. 17, 2010 (DE) 10 2010 051 656.2

(51) Int. Cl. F16L 53/00; F16L 3/00

(52) U.S. Cl. CPC F16L 53/00; F16L 3/00
USPC 137/334; 137/343

(57) ABSTRACT

A mounting for an injector includes at least one main body and a cap jointly or commonly forming a receptacle for the injector. The main body is formed of metal sheets which are connected to each other and together form at least one annular chamber which extends around the receptacle. In particular, a mounting for an injector is provided, which has a simple technical construction and can be cooled (optionally in a controlled manner). Moreover, the mounting has a particularly lightweight construction and is adapted to operation with considerable temperature differences. An injection device integrated in a mounting is also provided.

### CROSS-REFERENCE TO RELATED APPLICATION

This application is a continuation, under 35 U.S.C. §120, of copending International Application No. PCT/EP2011/067729, filed Oct. 11, 2011, which designated the United States; this application also claims the priority, under 35 U.S.C. §119, of German Patent Application DE 10 2010 048 284.6, filed Oct. 14, 2010 and German Patent Application DE 10 2010 051 656.2, filed Nov. 17, 2010; the prior applications are herewith incorporated by reference in their entirety.

### BACKGROUND OF THE INVENTION

### Field of the Invention

The present invention relates to a mounting for an injector which is constructed, in particular, for introducing a liquid substance into an internal combustion engine and/or an exhaust gas of an internal combustion engine. The invention also relates to an injector device integrated in the mounting.

It is known for liquids to be supplied to an internal combustion engine and/or to exhaust gas of the internal combustion engine in order, for example, to implement combustion of fuel in the internal combustion engine and/or treatment of the exhaust gas. Such injectors may, for example, be used for introducing fuel (for example gasoline or diesel) into the combustion chambers of an internal combustion engine, in which the injectors can be opened and closed at predefined times. It is likewise known for injectors to be used for supplying an additive, for example an oxidizing agent and/or a reducing agent, into the exhaust gas in order to bring about chemical reactions there with the pollutants in the exhaust gas at desired times. A urea-water solution may be used, for example as an additive, in such a way that a selective catalytic reduction (SCR process) of nitrogen oxides can be performed in the exhaust system.

In the case of such mountings for an injector, it must be taken into consideration that they are often positioned in an environment where high temperatures occur. The mountings may, for example, be fastened to an engine or to the exhaust line. In that case, the problem arises time and again that the injector must be protected against excessively high thermal loading. It is known for that purpose to provide, for example, insulation materials or separate cooling systems. The known systems are, however, in part technically very complex and/or cannot implement adequate protection for the injector.

### SUMMARY OF THE INVENTION

It is accordingly an object of the invention to provide a mounting for an injector and an injector device having an injector integrated in the mounting, which overcome the hereinafore-mentioned disadvantages and at least partially solve the highlighted problems of the heretofore-known mountings and devices of this general type. It is sought, in particular, to specify a mounting for an injector which has a technically simple construction and which can be cooled (if appropriate in regulated fashion). Furthermore, the mounting should have a particularly lightweight construction and be adapted for operation with considerable temperature differences.

With the foregoing and other objects in view there is provided, in accordance with the invention, a mounting for an injector. The mounting comprises at least one main body and a cap jointly or commonly forming a receptacle of the injector. The main body is formed by interconnected metal sheets which together form at least one annular chamber that extends around the receptacle.

It is preferable in this case for the main body and the cap to be configured substantially in such a way that they can receive the injector practically completely. It is furthermore preferable for both the cap and also the main body to be provided with thin-walled (metallic) components in order to thereby accomplish a low weight of the mounting and simpler production.

This also means, in other words, that the main body has at least two annular metal sheets which, if appropriate, have a complex shape and which partially delimit a cavity. The metal sheets are then joined together in such a way that the cavities thereof together form the at least one annular chamber. It is provided in this case that the at least one annular chamber is formed around a receptacle, situated at the inside, for the injector. It is thus possible for the injector to be positioned in the mounting in such a way that a substantial proportion of the injector is surrounded by the annular chamber which is adjacent radially at the outside. The annular chamber serves, in particular, to implement a spacing from the injector to the outer surface of the mounting, in such a way that the annular chamber can be utilized to form a heat barrier for the injector.

In accordance with another feature of the mounting of the invention, the at least one annular chamber is at least partially also formed by a housing of an integrated injector. This also means, in other words, that the interconnected metal sheets alone need not completely surround the annular chamber, but rather the metal sheets may, for example, form a gap with respect to one another in the direction of the receptacle, at which gap the housing of an integrated injector is then positioned. In this case, the at least one annular chamber is then delimited (only) by the first metal sheet, the second metal sheet and the housing of the integrated injector. This has the advantage, for example, that if the annular chamber is charged with a cooling medium, the cooling medium can come into direct contact with the housing of the injector, and effective cooling is thus attained. Furthermore, material for the mounting of the injector can be saved, so that weight and material costs can be further reduced.

In accordance with a further advantageous feature of the mounting of the invention, the metal sheets of the main body are deep-drawn components that are brazed to one another. It is very particularly preferable for the metal sheets to then form an overlap region in which a sealed brazed connection is provided (in particular in the form of an encircling seam). Metal sheets with a thickness of 0.1 to 2 mm [millimeters] may be used, for example, as deep-drawn components in which, for example, high-grade steel, steel or aluminum may be used as a material. Alternatively, it is also possible for a weld seam to be used for connecting the metal sheets, with the weld seam being produced, in particular, by using a laser welding process. It is likewise possible for the metal sheets to be connected by flanging or crimping.

In accordance with an added feature of the mounting of the invention, the main body is adhesively bonded or crimped to the housing of an integrated injector. This applies, in particular, to the variant in which the housing of an integrated injector is also utilized to delimit the at least one annular chamber. It is thus particularly preferable for one respective adhesive connection to be formed for one respective metal sheet adjacent that region of the housing which is utilized there for forming the annular chamber. Such adhesive connections can be provided in a very simple manner and with little cost outlay. The leak-tightness of the system may, if appropriate, be implemented by using suitable seals which are formed adjacent the at least one adhesive connection. Crimping (flanging) is to be understood to mean a joining process in which two components (in this case the main body and the housing) are connected to one another by plastic deformation. It would furthermore also be possible for the main body to be connected to the housing by welding or the like.

In accordance with an additional feature of the mounting of the invention, the at least one annular chamber has a widening in which an electric motor of an integrated injector is at least partially positioned. It is thereby accomplished, in particular, that for example the coil of the electric motor for the operation of the integrated injector can be cooled. In this case, the widening has the result that the mounting can have a very space-saving construction. For example, the annular chamber is formed with a smaller mean radius in the region of the fixing to the internal combustion engine or to the exhaust system than is the case further away from the internal combustion engine or from the exhaust system. Even though it is basically possible for every region to be formed with a separate annular chamber, it is preferable for only precisely one single annular chamber to be formed by the metal sheets of the main body.

It may also be advantageous for further elements of the injector to be positioned adjacent the annular chamber, and to thus likewise be able to be cooled during operation. This applies, for example, to a plug connector and/or to sections of the line for the injection fluid in which the injection fluid is (temporarily) stored in the injector such as, for example, between the valve and the outlet nozzle as well.

In accordance with yet another feature of the mounting of the invention, an electrical terminal of an integrated injector leads out of the mounting between the main body and the cap. In other words, that means, in particular, that the mounting is formed in such a way that the injector is received practically completely in the mounting, in particular in a sandwich-like manner between the (upper) cap and a (lower) main body. The electrical terminal serves, in particular, for the control of a motor or a dosing device for the supply of an injection fluid. The electrical terminal can be provided in a protected position directly in the vicinity of the widened annular chamber. Furthermore, an adequately large spacing with respect to the hot environment is attained in this way, in particular in interaction with actively regulated cooling implemented in the annular chamber.

In accordance with yet a further advantageous feature of the mounting of the invention, the at least one annular chamber is able to be connected to a cooling medium inlet and to a cooling medium outlet. For this purpose it is, for example, possible for holes to be provided in the metal sheets, in particular in only a single metal sheet, through which holes the inflow and the outflow of the cooling medium can be implemented. In this case, water in particular may be used as a cooling medium. The cooling medium may also be a mixture including water and at least one antifreeze agent. The at least one antifreeze agent lowers the freezing temperature of the cooling medium. It is thus possible to prevent the cooling medium from freezing. Depending on the structural variant of the mounting, the mounting may be damaged by freezing reducing agent. For certain structural variants of the mounting, therefore, it may be necessary for freezing to be prevented in an effective manner. For this purpose, the cooling medium preferably has an antifreeze agent fraction of at least 5 wt. % (percent by weight), preferably of at least 15 wt. %. The antifreeze agent lowers the freezing temperature of the cooling medium preferably to below −20 ° C., preferably even to below −30 ° C.

In accordance with yet an added feature of the mounting of the invention, the cap can be connected to an injection fluid port and has at least a centering device or an expansion compensation device, although both are preferably provided. Fuel or reducing agent, such as for example a urea-water solution, may for example be used as the injection fluid. For this purpose, the cap may for example receive a type of plug connector or connection piece through which the injection fluid is conducted to the integrated injector. For this purpose, the cap for example also abuts in a fluid-tight manner against the main body and/or against the electrical terminal of the integrated injector. The injector can thus, as required, draw the injection fluid to be delivered from an interior space of the cap or from the plug connector. In order to prevent malfunctions, it is therefore expedient for the cap or the plug connector to be aligned with respect to the integrated injector. In a connecting region in which the plug connector and the injector are connected to one another, a plug-in tube composed of metal or of a similar stable material may be inserted in order to stabilize the connection. This is done, in particular, to ensure the leak-tightness between the cap and the injector. It must furthermore be taken into consideration that the injection fluid may possibly freeze, which is generally associated with an increase in volume of the injection fluid in the region of the cap or of the plug connector. In order to now be able to also compensate such thermal changes in volume to a predefined extent, the cap should be provided with at least one expansion compensation device which is preferably integrated in the cap. The expansion compensation device or compensator is, in particular, constructed in such a way that, in a partial volume of the interior space of the cap, the entire volume expansion of the injection fluid collected there, and/or a resulting displacement of the plug connector, can be compensated. The expansion compensation device is thus preferably a separate component in the cap, formed for example with at least one spring element.

In accordance with yet an additional feature of the mounting of the invention, at least one guiding metal sheet is disposed in the at least one annular chamber and divides the annular chamber into an inner flow chamber and an outer flow chamber.

In accordance with again another feature of the mounting of the invention, at least one guiding metal sheet is disposed in the at least one annular chamber and divides the annular chamber into at least two flow chambers. The annular chamber may, for example, be divided by at least one guiding metal sheet into two flow chambers which in each case (approximately) semicircularly surround the injector. It is possible for the annular chamber to be divided by at least one guiding metal sheet into an upper flow chamber and a lower flow chamber, wherein the lower flow chamber is situated at an outlet end of the injector or at the exhaust-line side of the mounting, whereas the upper flow chamber is oriented towards the injection fluid port.

With regard to this embodiment, it is very particularly preferable for a single guiding metal sheet (which is preferably likewise a metallic deep-drawn component) to be disposed in the annular chamber. The guiding metal sheet preferably has a material thickness of at least 3 mm [millimeters], in particular of at least 5 mm, in such a way that the guiding metal sheet also functions as a component which stiffens the injector. Furthermore, the guiding metal sheet may have collars, necked formations, etc. provided thereon which ensure a secure connection to the cooling medium circuit.

The guiding metal sheet is, for example, fastened to the second metal sheet in such a way that the connecting seam has an encircling form and is positioned between the cooling medium inlet and the cooling medium outlet. From there, the guiding metal sheet preferably extends towards the discharge opening of the injector or towards the assembly location of the mounting on an exhaust line or on an engine. It is furthermore preferable for the major part of the guiding metal sheet to be positioned in the annular chamber with a spacing from the first metal sheet and from the second metal sheet. In this case, two flow chambers formed concentrically with respect to one another, specifically an inner flow chamber and an outer flow chamber, are preferably formed. A guiding metal sheet of this type can cause the cooling medium that enters the mounting, by using the guiding metal sheet, to be conveyed initially (downward) along the outer second metal sheet toward the injector opening, to flow around the guiding metal sheet there, and thus to flow into the inner flow chamber that is formed between the guiding metal sheet and the housing of the injector and the first metal sheet. The cooling medium is then conducted from there to the cooling medium outlet. In this way, the cooling medium at the outside at least partially flows in a different or opposite direction, and in the inner flow chamber a more intensive exchange of heat can take place due to the smaller dimensions in the direction of the injector or the electric motor of the injector. It is furthermore preferable for the inner flow chamber and the outer flow chamber to have approximately the same volume, and consequently for the annular chamber to be divided into approximately equal parts by the guiding metal sheet.

In a further structural variant, it is also possible for the cooling medium inlet and the cooling medium outlet to be connected to the annular chamber in such a way that the cooling medium firstly flows through the inner flow chamber between the guiding metal sheet and the first metal sheet and is subsequently diverted into the outer flow chamber between the second metal sheet and the guiding metal sheet. For this purpose, it is expedient for the cooling medium inlet to be connected to the inner flow chamber and for the cooling medium outlet to be connected to the outer flow chamber. This therefore causes coolant in the inner flow chamber, at a particularly low temperature, to be present directly at the injector, and coolant that has already been heated to be discharged through the outer flow chamber to the cooling medium outlet. A particularly low temperature of the injector can be obtained in this way.

It would basically also be possible for the annular chamber to be formed with two adjacent flow chambers, wherein the annular chamber is, for example, divided into a left-hand flow chamber and a right-hand flow chamber. The cooling medium would thus flow laterally into one flow chamber, be transferred through a connecting duct into the other flow chamber, and be discharged from there again laterally and in the opposite direction. Such a division may be expedient if the thermal loading of the injector is particularly great from one side, that is to say the injector is positioned, for example, at an acute angle with respect to the hot exhaust line.

With the objects of the invention in view, there is concomitantly provided a fluid injection device, comprising a fluid injector integrated in a mounting of the type described herein according to the invention and a cooling medium circuit connected to the at least one annular chamber. An injection device of this type may, in particular, be provided in conjunction with the supply of a fluid to the internal combustion engine or to an exhaust line of a motor vehicle. In this case, the fluid may be stored in a separate reservoir and be conducted to the injector as required. Likewise provided is a cooling medium circuit, wherein water, for example, is delivered repeatedly in the manner of a circuit through the annular chamber of the mounting in such a way that effective cooling can take place there.

Other features which are considered as characteristic for the invention are set forth in the appended claims, noting that the features specified individually in the claims may be combined with one another in any desired technologically expedient manner and form further embodiments of the invention.

Although the invention is illustrated and described herein as embodied in a mounting for an injector and an injector device having an injector integrated in the mounting, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a structural variant of a mounting according to the invention with an integrated injector;

FIG. 2 is a cross-sectional view of a further structural variant of the mounting according to the invention with an integrated injector; and

FIG. 3 is a block diagram of a motor vehicle having a corresponding injection device.

### DETAILED DESCRIPTION OF THE INVENTION

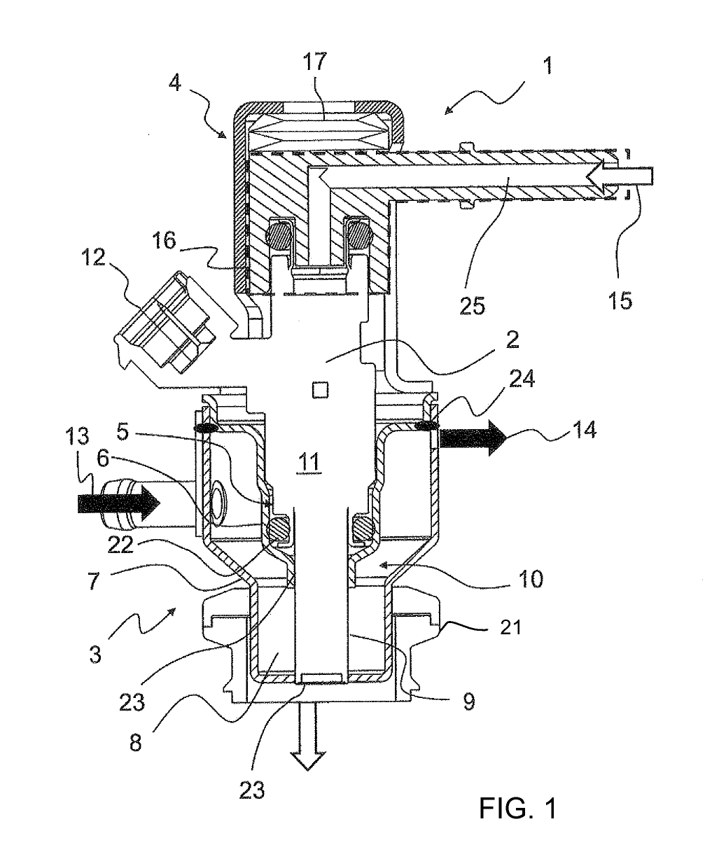

Referring now in detail to the figures of the drawings which show particularly preferred structural variants to which the invention is not restricted and in which reference numerals generally denote identical components and first, particularly, to FIG. 1 thereof, there is seen a diagrammatic cross section illustrating a construction of a mounting 1 for an injector 2 which, in this case, has already been integrated into the mounting 1. An internal combustion engine 21 can be seen at the bottom of FIG. 1 as well as a main body 3 of the mounting 1 which is disposed so as to project into a duct or an opening of the internal combustion engine 21. In this case, the main body 3 is formed by a first metal sheet 6 and a second metal sheet 7. In this case, the configuration is such that the second metal sheet 7 practically completely forms an outer surface of the main body 3. In this case, the second metal sheet 7 and the first metal sheet 6 are formed as deep-drawn components. The first metal sheet 6 forms an abutment region or overlap region with the second metal sheet 7 in an upper region of the main body 3 and a brazed connection 24 is formed there. The first metal sheet 6 then extends, spaced apart from the second metal sheet 7, into inner regions of the second metal sheet 7. As a result of the spacing of the first metal sheet 6 and the second metal sheet 7, an annular chamber 8 is formed. In this case, the contour of the first metal sheet 6 is selected in such a way that a suitable receptacle 5 for the injector 2 is formed.

In the structural variant shown therein, the annular chamber 8 is formed not only by the first metal sheet 6 and the second metal sheet 7. In fact, it is also the case herein that a housing 9 of the injector 2 serves, in part, to delimit the annular chamber 8. For this purpose, the first metal sheet 6 and the second metal sheet 7 are formed so as to abut against the housing 9 at points spaced apart from one another. In the abutment regions, an adhesive connection 23 is formed in such a way that the first metal sheet 6 and the second metal sheet 7 are in each case adhesively bonded to the housing 9 of the injector 2. For sealing purposes, it may be expedient for an additional seal 22, for example in the form of an O-ring, to be provided adjacent the upper adhesive connection 23 so as to prevent cooling medium situated in the annular chamber 8 from escaping therefrom.

FIG. 1 also shows that the injector 2 has a central electric motor 11, at which the injector 2 has a widened form. In order to form a suitable receptacle 5 in this case, a widening 10 of the annular chamber 8 is provided. This achieves a construction in which cooling medium is situated around the outside of the electric motor 11 of the injector 2 so that the cooling medium ensures permanent operation of the injector 2. For this purpose, corresponding measures, for example openings, for realizing a cooling medium inlet 13 and a cooling medium outlet 14, are provided in the outer second metal sheet 7. It is preferable for the cooling medium inlet 13 to be positioned closer to the outlet of the injector 2 or closer to the hot fastening of the mounting 1.

A cap 4 is provided above the main body 3. In this case, the cap 4 is also formed as a substantially cylindrical deep-drawn component which is closed on one side. The cap 4 receives a plug connector 25 (in the form of an injection fluid port 15) which interacts with the integrated injector 2. The plug connector 25 is oriented in the cap 4 by a centering device 16. The cap 4 is connected to the main body 3, in this case in particular to the first metal sheet 6, by brazing. An electrical terminal 12 of the injector 2 projects out in a central region of the mounting 1, that is to say between the main body 3 and the cap 4. Control lines which regulate the operation of the injector 2 can then be connected to the electrical terminal. The external form or shape of the cap 4 is generally configured in such a way that the plug connector 25 for the connection of the injection fluid is centered on the injector 2, so that a sealed connection of the plug connector 25 to the injector 2 is realized. However, guide surfaces or guide edges (on the cap 4), which are particularly suitable, may also be provided for this purpose. Since injection fluid may possibly be temporarily stored in the plug connector 25 for a long period of time, for example during a long standstill period of the motor vehicle, it must be taken into consideration that the injection fluid located there may increase in volume due to the formation of ice. This may possibly lead to the contact between the plug connector 25 and the injector 2 being changed. In this case, in order to compensate for such an occurrence, a plate spring is provided in the region of the cap 2 as an expansion compensation device or compensator 17. The plate spring permits a (precisely limited) relative movement for the purpose of pressure relief.

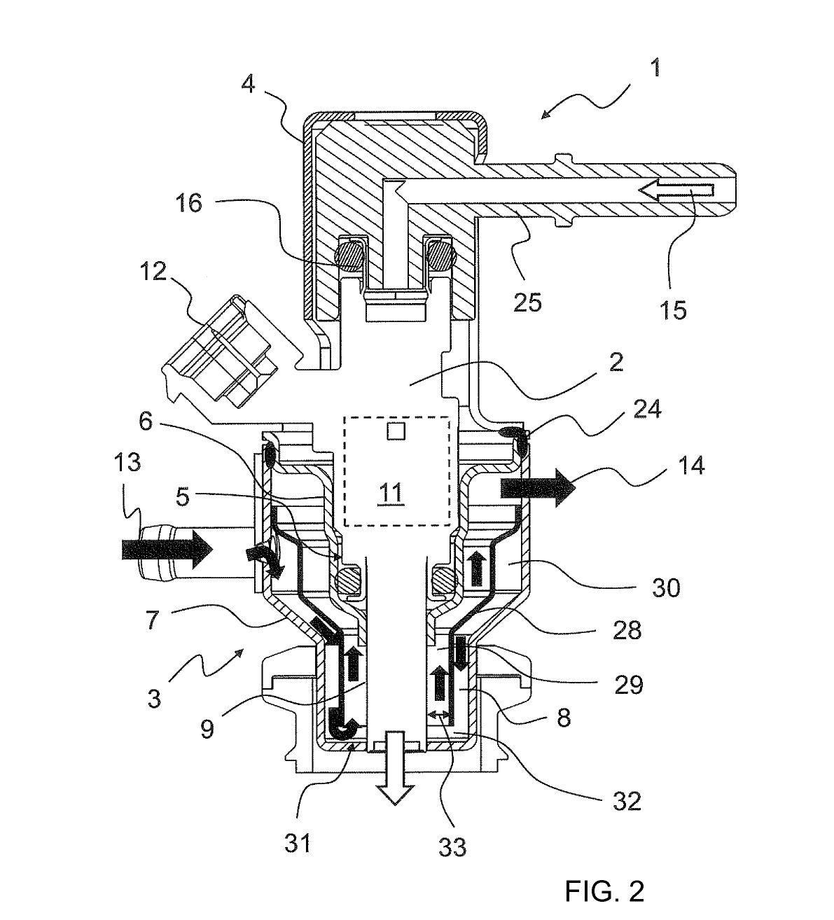

FIG. 2 shows a cross section through a further structural variant of the mounting 1 according to the invention with an integrated injector 2. It is pointed out that the reference numerals as used in conjunction with FIG. 1 denote identical components therein. Below, therefore, reference will be made, in particular, to those features which differ in relation to FIG. 1.

It is firstly noted, with regard to the plug connector 25, that the plug connector is likewise oriented in the cap 4 by a centering device 16. In this case, the centering device 16 is situated at the inside relative to the plug connector 25 and, proceeding from the injector 2 is formed, for example, in the manner of spring elements.

As a major difference in comparison to FIG. 1, FIG. 2 shows a single guiding metal sheet 28 which is positioned in the annular chamber 8. The guiding metal sheet 28 is fixed, in particular welded (for example by laser welding) or adhesively bonded, in an upper partial section of the second metal sheet 7, specifically between the cooling medium inlet 13 and the cooling medium outlet 14. From there, the guiding metal sheet 28 tapers in the direction of the first metal sheet 6 until it runs approximately centrally between the first metal sheet 6 and the second metal sheet 7. From there, the guiding metal sheet approximately centrally follows the profile of the second metal sheet 7 or of the first metal sheet 6 or the housing 9 of the injector 2 (downward) toward the opening of the injector 2 or a base 31 of the annular chamber 8. The guiding metal sheet 28 ends shortly before reaching the base 31 of the annular chamber 8 (for example by defining a gap 32 which corresponds approximately to a spacing 33 of the guiding metal sheet 28 from lateral boundaries). The shape of the guiding metal sheet 28 can be described, for example, as a multiply stepped cone. The guiding metal sheet 28 serves to form an inner flow chamber 29 and an outer flow chamber 30 which are connected to one another only through the gap 32 close to the base 31 of the annular chamber 8. In this case, the guiding metal sheet 28 performs the task of realizing a targeted flow direction, and predefined contact of the cooling medium with parts of the mounting 1 and of the injector 2. With regard to the throughflow direction for the cooling medium indicated therein, the cooling medium firstly enters the annular chamber 8, specifically the outer flow chamber 30, through the cooling medium inlet 13. The cooling medium is then conducted downward in the direction of the opening of the injector 2 by the guiding metal sheet 28 and the second metal sheet 7. When the cooling medium reaches the base 31 of the annular chamber 8, it flows around the guiding metal sheet 28 and enters the inner flow chamber 29. There, guided at one side by the guiding metal sheet 28 and at the other side by the housing 9 of the injector and by the first metal sheet 6, the cooling medium flows upward again toward the cooling medium outlet 14. Such targeted flow guidance has the advantage, in particular, that the cooling medium ensures an intensive exchange of heat in the particularly hot region of the mounting 1 close to the base 31 of the annular chamber 8 or in the direct vicinity of the injector 2. It is furthermore still pointed out that a connection may be formed between the second metal sheet 7 and the first metal sheet 6 in the region of the base 31, in particular by brazing, welding or crimping.

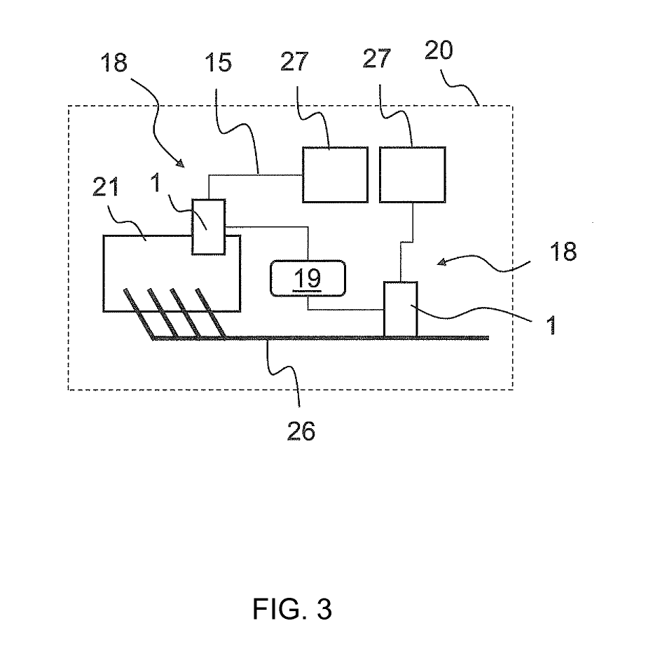

FIG. 3 is a block diagram once again showing a possible construction of injection devices 18 of this type. The figure shows a motor vehicle 20 having the internal combustion engine 21, an exhaust line 26 and a mounting 1 which may be fastened to the internal combustion engine 21 and/or to the exhaust line 26. It is thus possible for the desired injection fluid, which is stored in a suitable reservoir 27 and supplied by the injection fluid port 15, to be metered into the internal combustion engine 21 and/or the exhaust line 26 by the integrated injector 2. The mounting 1, in particular the main body 3 of the mounting 1, in this case is connected to a (common) cooling medium circuit 19, in such a way that it is possible at all times for cooling medium at a desired low temperature to be supplied to the annular chamber in the main body 3.

The present invention thus at least partially solves the problems highlighted with regard to the prior art. There is specified, in particular, a mounting for an injector which has a technically simple construction and which can be cooled (if appropriate in regulated fashion). Furthermore, the mounting has a particularly lightweight construction and is adapted for operation with considerable temperature differences.

1. A mounting for an injector, the mounting comprising:
at least one main body and a cap jointly forming a receptacle for the injector;
said at least one main body being formed by interconnected metal sheets together forming at least one annular chamber extending around said receptacle.

2. The mounting according to claim 1, wherein said injector is integrated in the mounting and has a housing, and said at least one annular chamber is at least partially formed by said housing.

3. The mounting according to claim 1, wherein said metal sheets of said at least one main body are deep-drawn components being brazed to one another.

4. The mounting according to claim 1, wherein said injector is integrated in the mounting and has a housing, and said at least one main body is adhesively bonded or crimped to said housing.

5. The mounting according to claim 1, wherein said injector is integrated in the mounting and has an electric motor, and said at least one annular chamber has a widening in which said electric motor is at least partially positioned.

6. The mounting according to claim 1, wherein said injector is integrated in the mounting and has an electrical terminal leading out of the mounting between said at least one main body and said cap.

7. The mounting according to claim 1, which further comprises a cooling medium inlet and a cooling medium outlet, said at least one annular chamber being configured to be connected to said cooling medium inlet and to said cooling medium outlet.

8. The mounting according to claim 1, which further comprises an injection fluid port, said cap configured to be connected to said injection fluid port and having at least a centering device or an expansion compensation device.

9. The mounting according to claim 1, which further comprises at least one guiding metal sheet disposed in said at least one annular chamber, said at least one guiding metal sheet dividing said at least one annular chamber into an inner flow chamber and an outer flow chamber.

10. A fluid injection device, comprising:
a mounting according to claim 1;
a fluid injector integrated in said mounting; and
a cooling medium circuit connected to said at least one annular chamber of said mounting.
